(19) United States
(12) Patent Application Publication
(10) Pub. No.: US 2006/0149779 A1
(43) Pub. Date: Jul. 6, 2006

(54) Method and apparatus for integrating electronic systems

(76) Inventors: Jean-Pierre Paillet, Ottawa (CA); Paul Verschueren, Sale (GB)

Correspondence Address: IBM CORPORATION;INTELLECTUAL PROPERTY LAW, 11400 BURNET ROAD, AUSTIN, TX, 78758, US

(21) Appl. No.: 11/299,259

(22) Filed: Dec. 9, 2005

(30) Foreign Application Priority Data
Dec. 31, 2004 (GB) 0428570.6

(51) Int. Cl. G06F 17/00; G06F 7/00

(52) U.S. Cl. 707/102

(57) ABSTRACT

A method for integrating electronic systems comprises acquiring a set of business scenarios, the business scenarios relating to the electronic systems to be integrated, executing, for each business scenario, a collaboration analysis, an interaction analysis, and a component selection, and composing a finalised architecture dependent upon the outcome of the component selection.

This invention relates to a method for integrating electronic systems, and to corresponding apparatus.

Integration of electronic business systems is a major technological problem. Most old (legacy) systems were designed in vertical functional “stovepipes”, and the modern focus on horizontally integrated business processes can only be supported by horizontally integrated systems. The integration of such systems is a complex activity and traditionally has not been executed in a systematic manner.

It is therefore an object of the invention to improve upon the known art.

According to a first aspect of the present invention, there is provided a method for integrating electronic systems comprising acquiring a set of business scenarios, the business scenarios relating to the electronic systems to be integrated, executing, for each business scenario, a collaboration analysis, an interaction analysis, and a component selection, and composing a finalised architecture dependent upon the outcome of the component selection.

According to a second aspect of the present invention, there is provided apparatus for integrating electronic systems comprising a processor arranged to acquire a set of business scenarios, the business scenarios relating to the electronic systems to be integrated, to execute, for each business scenario, a collaboration analysis, an interaction analysis, and a component selection, and to compose a finalised architecture dependent upon the outcome of the component selection.

According to a third aspect of the present invention, there is provided a computer program product on a computer readable medium for controlling a system for integrating electronic systems, the computer program product comprising instructions for acquiring a set of business scenarios, the business scenarios relating to the electronic systems to be integrated, for executing, for each business scenario, a collaboration analysis, an interaction analysis, and a component selection, and for composing a finalised architecture dependent upon the outcome of the component selection.

Owing to the invention, it is possible to provide a tool for assisting and regulating the process of integrating electronic systems. The process guides a designer in producing a robust technical solution to an electronic business integration problem. The designer follows a series of steps which guide him in decomposing a complex problem into simpler elements to achieve a solution.

In the system integration method and apparatus, the acquiring of the set of business scenarios comprises creating the set of business scenarios or comprises receiving the set of business scenarios. The business scenario for an electronic business system comprises detail of the expected use of the system and would normally include further information on such issues as functionality, security and availability. The business scenarios may already exist for the electronic systems to be integrated, or may need to be generated specifically for the process.

Advantageously, the process further comprises, prior to the acquiring of the set of business scenarios, creating a solution overview diagram, the solution overview diagram outlining structural characteristics of the architecture. The business integration process can be executed without a solution overview diagram (SOD) or the equivalent. However the use of an SOD, produced using, for example, the Patterns for e-Business process, as described in US 2003/0040920, will greatly assist the system integration.

Preferably, the collaboration analysis comprises decomposing collaborations to obtain interactions, each interaction identifying an initiating event. The collaboration analysis uses collaboration patterns to identify clusters of behaviour which must occur to support the functions of an individual electronic system, and associates them with a refined specification of the Qualities of Service.

Ideally, the interaction analysis comprises decomposing interactions and defining context flows. The interaction analysis focuses on interactions, which are categorised by a specific pattern of action. During this phase of the process, interaction patterns are utilised to assist in categorising the features of the action, with attention given to the organisation of behaviour (sequencing, co-ordination and so on), the management of multiple protocol layers and the local support for Qualities of Service.

Advantageously, the component selection comprises identifying, filtering and ranking candidate components. The component selection phase of the process synthesises the findings of the previous two steps into an articulation of the functional groupings suitable for mapping onto known systems, or for detailed specification if any component is to be custom built.

Preferably, the step of composing a finalised architecture comprises merging interactions and collaborations, and identifying and resolving conflicts. If an SOD is being used in the process, then the results for each business scenario are integrated into the SOD, which evolves as the behavioural analysis brings in new details and constraints. The identification and resolution of conflicts at this stage is an important step in ensuring that the resulting architecture is stable and robust.

Embodiments of the present invention will now be described, by way of example only, with reference to the accompanying drawings, in which:

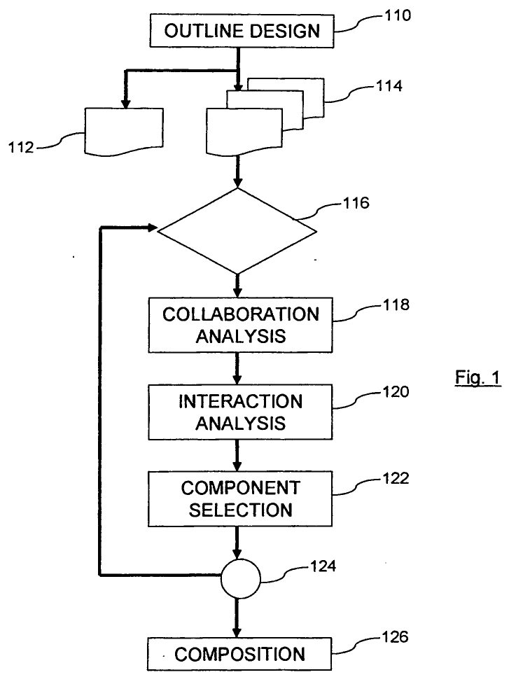

FIG. 1 is a flowchart of a summary of the system integration process,

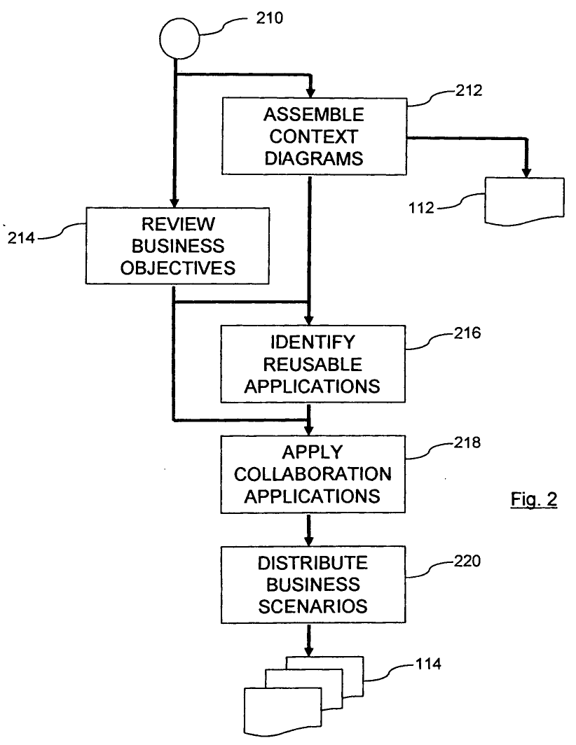

FIG. 2 is a flowchart of the outline design phase of the system integration process,

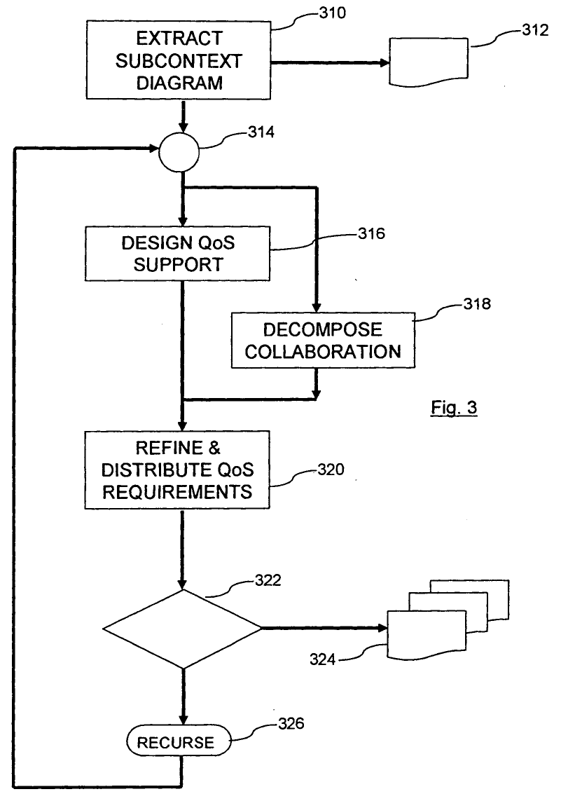

FIG. 3 is a flowchart of the collaboration analysis phase of the system integration process,

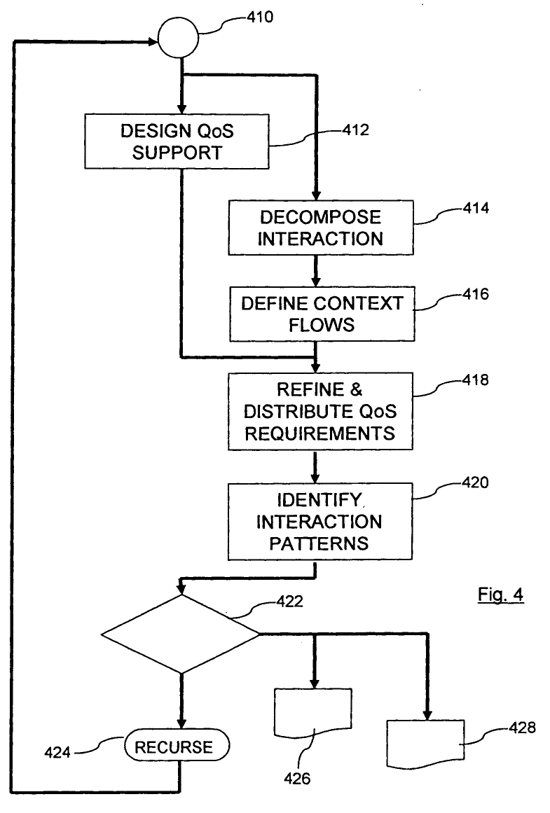

FIG. 4 is a flowchart of the interaction analysis phase of the system integration process,

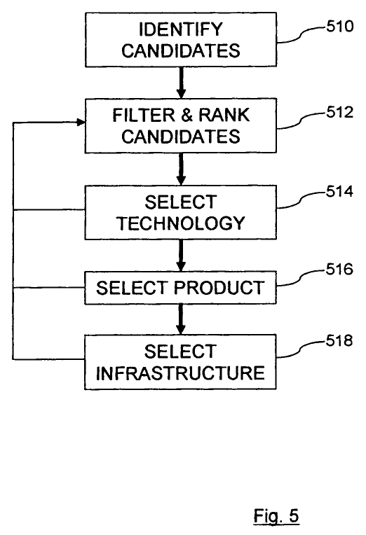

FIG. 5 is a flowchart of the component selection phase of the system integration process, and

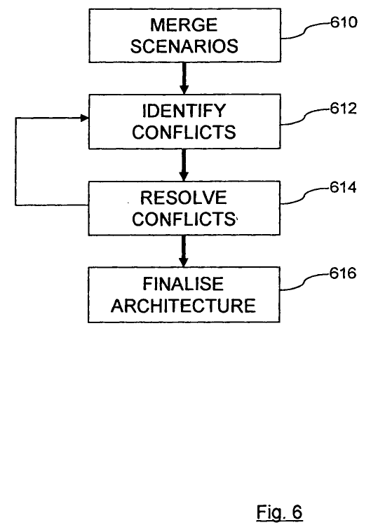

FIG. 6 is a flowchart of the composition phase of the system integration process.

In the process overview flowchart of FIG. 1, the first step 110 is the outline design phase, which will be discussed in more detail below, with reference to FIG. 2. The principal purpose of the outline design stage is to generate an overview diagram 112 and to create a set of business scenarios 114, one for each of the major business uses of the overall solution. The solution overview diagram 114 is used to guide the whole process and is adapted during the process, while the business scenarios 114 are used as the inputs to the future process steps.

Following creation of the business scenarios 114, the process moves to the step 116, which along with the control 124 ensure that the major process steps 118, 120 and 122 are executed for each business scenario 114.

Step 118 is the collaboration analysis, discussed below in more detail with reference to FIG. 3. Following the stage 118 is the step 120, which is the interaction analysis (FIG. 4), which is followed by the component selection stage 122 (FIG. 5), which passes to the control 124. Once the stages 118 to 122 have been executed for all of the business scenarios 114, then the control 124 will pass the process to the stage 126, which is the composition phase (FIG. 6).

In the composition phase 126, the results of the analyses and component selection for each business scenario is merged into a complete picture, with conflicts identified and resolved. A finalised architecture is decided upon, and the integration of the various systems can be achieved.

FIG. 2 shows in more detail the outline design phase 110 of the process. The focus in this stage is on interfacing with the working context. Applying the design approach in given circumstances requires taking stock of the available information and shaping all documentation to the needs of the subsequent steps in the integration process, which provide the substantive contribution to the overall design of the integration solution.

This stage is initiated at control 210, and moves to stage 212, which involves the assembling of context diagrams. These context diagrams will be used to create the overview diagram 112. The overview diagram 112 translates the textual business description into a pictorial representation of structure. The overview diagram 112 identifiers the users of the individual electronic systems being integrated and of external systems that are interacted with. The overview diagram 112 also identifies major new or modified business functions and major existing business functions that cannot be modified. The diagram 112 also shows the interactions between the users and the business functions.

In parallel to stage 212, at step 214 of the outline design phase, the process step of reviewing business objectives is executed. This is to ensure that the designer of the system integration project or team of designers has a full understanding of the business needs and objectives of the integration. The objectives can be reformulated as required to take into account the various priorities and impact of any decisions taken.

At step 216, the task of identifying reusable applications is executed. With regard to the systems that are being integrated, various features of those systems are considered to see if any of the features can be reused in the ultimate solution to the system integration. These features will be such things the overall topology of the systems, the existing technical infrastructure that is used, the actual application components themselves and the patterns within the systems. It is also a function of this task 216 to identify any missing functionality, with regard to the overall object of the fully integrated system.

Following the task 216, the next process step is step 218, which is to apply collaboration patterns to the solution overview diagram 114 to produce a refined solution overview diagram. The identified business and technical needs of the overall solution are used to drive the application of collaboration patterns and to draw up the initial list of Quality of Service requirements. These (and other patterns mentioned in this document) are a subset of the publicly available ‘IBM Patterns for e-business’. These patterns are used to address issues of general topology, service zones, governance and design flexibility. A Quality of Service (QoS) capability framework is used to organise a QoS analysis.

The final task in the outline design phase of the process is to identify and prioritise the set of one or more business scenarios which will form the input to subsequent steps of the process. Each scenario describes one of the major business uses of the overall solution, and how the solution must operate in order to support this business use.

Once the business scenarios 114 have been developed by the process, then the three steps of collaboration analysis 118, interaction analysis 120 and component selection 122 are executed for each business scenario 114, in turn. The process steps for the collaboration analysis 118 are shown in more detail in FIG. 3.

The first stage 310 that is carried out for a business scenario is the extraction of a subcontext diagram 312 for that business scenario. The subcontext diagram 312 is extracted from the system overview diagram 112 and restricts information of the overview diagram 112 to elements relevant to the current business scenario. This is achieved by tracing the business scenario story through the overview diagram 112, and removing those elements that are not touched by the walkthrough.

Once the subcontext diagram 312 has been created, the process passes to the control 314, which concurrently passes to the steps 316 and 318. The step 316 is the step of designing the Quality of Service (QoS) support. This starts from the general QoS requirements and involves the filtering and refining of the QoS as applied to the current business scenario. Detail is added as uncovered in the walkthrough process.

At the same time, the step 318 of decomposing the collaborations is carried out. Within the structure of the current business scenario, as defined in the subcontext diagram 312, all of the collaborations within the current scenario are examined for several different aspects and may be decomposed into sub collaborations. These aspects include the natural topological division, governance constraints and the reuse of existing topology. Collaboration patterns are used to identify and classify the significant clusters of behaviour which are invoked in the execution of the business scenario.

Following the completion of the steps 316 and 318, the process moves to the step 320, which is the refining and distributing of the QoS requirements. The execution of this step requires, for each new subcollaboration introduced in step 318, the determination of applicable elements of QoS, the documentation of the relationship to the overall context and the documentation of technical architecture requirements.

The next stage in the collaboration analysis stage is the step 322 which is a check to see if all of the interactions within the business scenario have been identified. If any collaboration involves multiple initiating events, then further decomposition is required, and so the process passes to the recursion stage 326 which returns the process to the control 314. When the collaborations being analysed qualify as interactions, then this recursive process terminates, with initial interaction diagrams 324 being produced, which identify interactions, being simple collaborations that identify a single initiating event.

The interaction analysis phase 120, shown in FIG. 4, begins with the control 410 and passes to the design of QoS support stage 412. This starts from the QoS requirements distributed to this particular interaction The QoS are filtered and refined as applied to the current interaction. Further detail may be added as uncovered in the walkthrough process 414.

Concurrently with the stage 412, the steps 414 and 416 are executed. The stage 414 is where the decomposition of the interaction being considered takes place. If the interaction is considered to be complex, then a walkthrough is used to identify simpler constituent interactions. In the decomposition process, as required, initiation, flow models, coupling and synchronisation are isolated and described.

Following the stage 414, the stage 416 of defining context flows is executed. If relevant, context flow descriptors are used to describe protocol rules, message formats and the context governing interaction such as session context and transactionality etc.

At step 418, the refining and distributing of the QoS requirements is processed. The execution of this step requires, for each constituent interaction identified in 414, the determination of applicable elements of QoS, the documentation of the relationship to the overall context and the documentation of technical architecture requirements.

The process then moves on to step 420, at which point each interaction is identified and classified using interaction patterns.

Following step 420 is the query stage 422, at which point in the process of interaction analysis is repeated for any complex interactions which need to be further broken down into sub-interactions. Recursion is carried out on each interaction until enough detail is available for component selection. Once all the interactions have been sufficiently decomposed a logical design document 426 and a QoS strategy 428 will be available. The logical design document 426 is an articulation of the topology in terms of interaction patterns and the QoS strategy 428 is a collection of technical components, configuration parameters and data to support analysed qualities of service.

Once the interaction analysis has been completed, the componentisation phase is executed, as shown in FIG. 5. The first step 510 is to identify candidates for use in the finalised integrated system. These components must support the analysed interactions. Once the candidates have been identified, then at step 512, they are filtered and ranked, with each candidate being graded for each QoS element. Candidates are ranked according to overall fitness for the purpose they fulfil in the ultimate system.

Once potential candidates have been ranked, then at step 514, the technology to be used must be selected, if several different technologies can be used, taking into account current technologies used, the existing technical architecture and future plans for the ultimate system. Once the technology has been chosen, then at step 516, if several different products are appropriate, then product selection must be made.

The final step in the component selection phase is the step 518, which is the selection of the infrastructure, which involves mapping the selected technology and product requirements onto the existing infrastructure and reviewing the gaps, with reference to possible simplification of maintenance and future plans.

Once the component selection has been completed, then the composition phase of the integration of the systems will take place. This process is shown in FIG. 6. In that Figure, the first stage is the step 610 of merging the scenarios. This stage 610 comprises, for each scenario, merging the interactions and collaborations into a scenario collaboration, associating components and products with the composed collaborations, and using the initial business integration overview as a guide to merge the business scenario into the overview, to merge the corresponding components into a functional architecture, to merge the associated products into a deployment model and to merge the associated infrastructure into a physical model.

The second step 612 in this process is to identify conflicts. At each of the merger steps checks for possible conflicts are made between associated components, between products and prerequisites, between deployment specifications, in the technical infrastructure and in the configuration, business rules and metadata.

For each detected conflict, at stage 614, all conflicts are resolved. for each detected conflict, architecture decisions are traced back in analysis, the origin of any discrepancy is located, and the discrepancy is corrected with all changes propagated and any possible induced conflicts are detected (with the identification and resolution of conflicts being repeated if necessary).

The final step, in the overall process, is the step 616, which is the finalisation of the ultimate architecture of the integrated electronic system. At this stage, the technical infrastructure, the deployment model, the logical model, the products and configuration, and the metadata are all finalised. The design process at this point is now complete, and the process for integrating the electronic systems is now finished, with a defined architecture for the new integrated system defined and documented.

1. A method for integrating electronic systems comprising acquiring a set of business scenarios, the business scenarios relating to the electronic systems to be integrated, executing, for each business scenario, a collaboration analysis, an interaction analysis, and a component selection, and composing a finalised architecture dependent upon the outcome of the component selection.

2. A method according to claim 1, wherein the step of acquiring the set of business scenarios comprises creating the set of business scenarios.

3. A method according to claim 1, wherein the step of acquiring the set of business scenarios comprises receiving the set of business scenarios.

4. A method according to claim 1, further comprising, prior to the acquiring of the set of business scenarios, creating a solution overview diagram, the solution overview diagram outlining structural characteristics of the architecture.

5. A method according claim 1, wherein the collaboration analysis comprises decomposing collaborations to obtain interaction diagrams, each interaction diagram identifying an initiating event.

6. A method according to claim 1, wherein the interaction analysis comprises decomposing interactions and defining context flows.

7. A method according to claim 1, wherein the component selection comprises identifying, filtering and ranking candidate components.

8. A method according to claim 1, wherein the step of composing a finalised architecture comprises merging interactions and collaborations, and identifying and resolving conflicts.

9. Apparatus for integrating electronic systems comprising a processor arranged to acquire a set of business scenarios, the business scenarios relating to the electronic systems to be integrated, to execute, for each business scenario, a collaboration analysis, an interaction analysis, and a component selection, and to compose a finalised architecture dependent upon the outcome of the component selection.

10. Apparatus according to claim 9, wherein the processor is arranged to create the set of business scenarios.

11. Apparatus according to claim 9, wherein the processor is arranged to receive the set of business scenarios.

12. Apparatus according to claim 9, wherein the processor is further arranged, prior to the acquiring of the set of business scenarios, to create a solution overview diagram, the solution overview diagram outlining structural characteristics of the architecture.

13. Apparatus according to claim 9, wherein the collaboration analysis comprises decomposing collaborations to obtain interaction diagrams, each interaction diagram identifying an initiating event.

14. Apparatus according to claim 9, wherein the interaction analysis comprises decomposing interactions and defining context flows.

15. Apparatus according to claim 9, wherein the component selection comprises identifying, filtering and ranking candidate components.

16. Apparatus according to claim 9, wherein the processor composing a finalised architecture comprises merging interactions and collaborations, and identifying and resolving conflicts.

17. A computer program product on a computer readable medium for controlling a system for integrating electronic systems, the computer program product comprising instructions for acquiring a set of business scenarios, the business scenarios relating to the electronic systems to be integrated, for executing, for each business scenario, a collaboration analysis, an interaction analysis, and a component selection, and for composing a finalised architecture dependent upon the outcome of the component selection.

18. A computer program product according to claim 17, wherein the step of acquiring the set of business scenarios comprises creating the set of business scenarios.

19. A computer program product according to claim 17, wherein the step of acquiring the set of business scenarios comprises receiving the set of business scenarios.

20. A computer program product according to claim 17, further comprising, prior to the acquiring of the set of business scenarios, instructions for creating a solution overview diagram, the solution overview diagram outlining structural characteristics of the architecture.

21-24. (canceled)
